(19) United States
(12) Patent Application Publication
(10) Pub. No.: US 2020/0238113 A1
(43) Pub. Date: Jul. 30, 2020

(54) WILDFIRE CONTAINMENT BARRIER

(71) Applicant: William Glaser, Berkeley, CA (US)

(72) Inventor: William Glaser, Berkeley, CA (US)

(21) Appl. No.: 16/752,604

(22) Filed: Jan. 24, 2020

Related U.S. Application Data
(60) Provisional application No. 62/796,365, filed on Jan. 24, 2019.

(51) Int. Cl. A62C 3/02

(52) U.S. Cl. CPC A62C 3/0257

(57) ABSTRACT

A system and method for deployable barrier, deployed along a surface that can include: a receptacle that includes a set of walls that are at least partially made of a flexible material and that define at least one sub-channel extending along a length of the receptacle, and the receptacle comprising an inlet to the at least one sub-channel; wherein the receptacle can be arranged in a collapsed configuration; and a filler material that when introduced into the at least one sub-channel through the inlet expands the receptacle into a deployed configuration and thereby forming a barrier with an expanded form. The deployable barrier can have applications and customized features for fire containment and mitigation, flood containment, and/or other applications.

### CROSS REFERENCE RELATED TO APPLICATION

This Application claims the benefit of U.S. Provisional Application No. 62/796,365, filed on 24 JAN. 2019, which is incorporated in its entirety by this reference.

### TECHNICAL FIELD

This invention relates generally to the field of fire containment and more specifically to a new and useful system and method for a wildfire containment barrier.

### BACKGROUND

Wildfires are becoming increasingly common and destructive as a result of many factors. More common extreme weather conditions and population growth into fire prone areas are two such factors. Once ignited, fires can spread rapidly to the point where they become difficult to contain.

A common method, particularly in rural and forest areas, to control the spread of fire is a firebreak. A firebreak is a gap in vegetation or other combustible material that acts as a barrier to slow or stop the progress of a fire. A firebreak may occur naturally, such as a river or canyon, where there is a lack of vegetation or other fuel. Firebreaks may be man-made and many serve as roads. The creation of firebreaks however is time consuming, costly, and sometimes impractical based on the terrain.

Unfortunately, the unpredictability of a fire can often negate the benefits of a firebreak that is either not in the correct area or that has been somehow circumvented. Thus, there is a need in the field of fire containment to create a new and useful system and method for a deployable barrier and more specifically a wildfire containment barrier. This invention provides such a new and useful system and method.

### BRIEF DESCRIPTION OF THE FIGS.

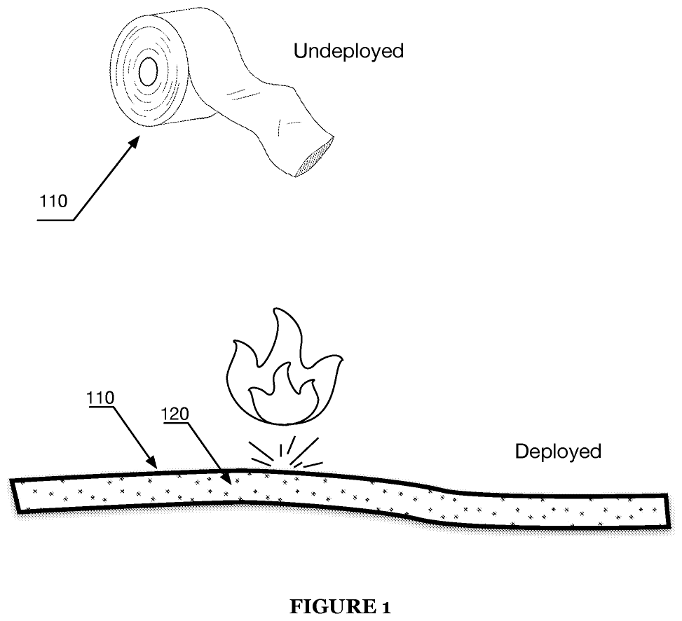

FIG. 1 is a schematic representation of a system of a preferred embodiment;

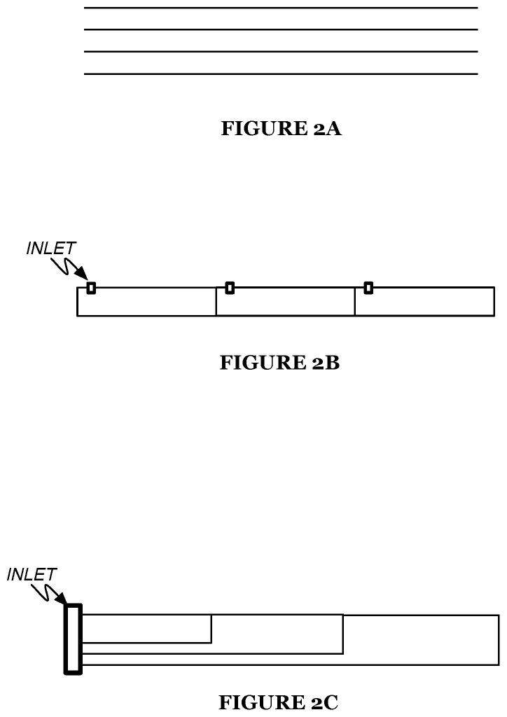

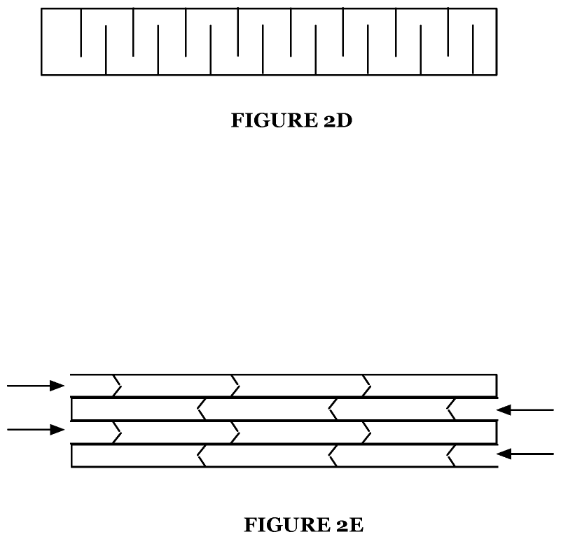

FIGS. 2A-2E are detailed schematics of exemplary receptacle structures; and

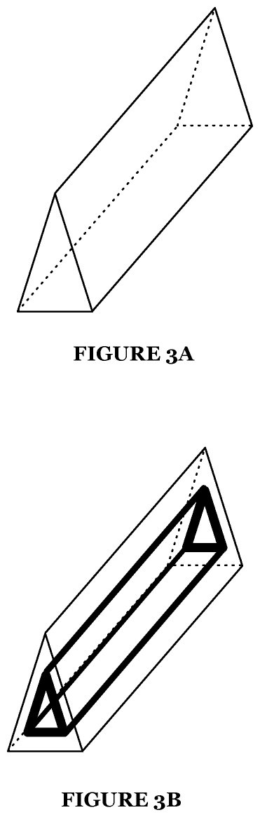

FIG. 3A is a schematic of an exemplary receptacle structure of non-circular geometry;

FIG. 3B is a schematic of an exemplary multi-layer receptacle structure of non-circular geometry;

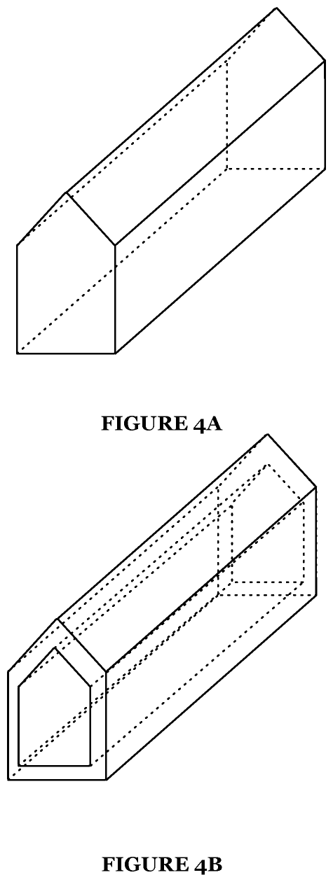

FIG. 4A is a schematic of an exemplary receptacle structure of non-circular geometry;

FIG. 4B is a schematic of an exemplary multi-layer receptacle structure of non-circular geometry;

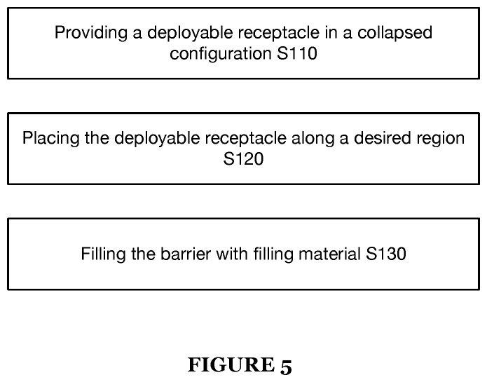

FIG. 5 is a flow diagram representation of a method of a preferred embodiment;

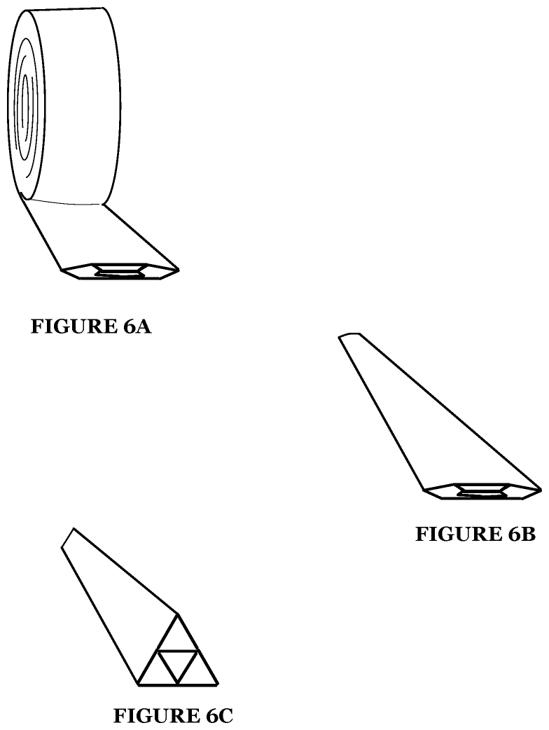

FIGS. 6A-6C are schematic representations showing a side profile as a receptacle is transitioned from a collapsed configuration to deployed configuration;

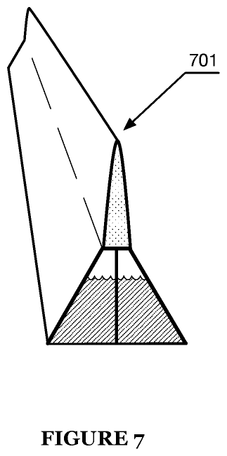

FIG. 7 is a schematic representation of an exemplary variation with a vertical extension sub-channel;

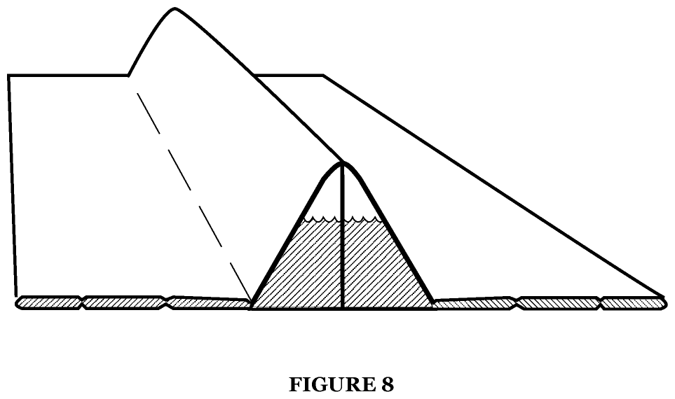

FIG. 8 is a schematic representation of an exemplary variation with two horizontal extension sub-channels;

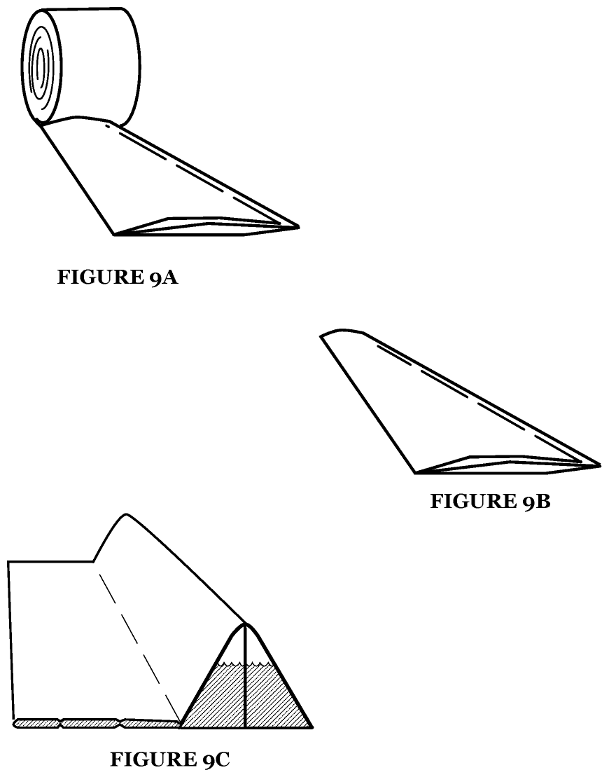

FIGS 9A-9C are schematic representations showing a side profile as a receptacle with a horizontal extension sub-channel is transitioned from a collapsed configuration to deployed configuration;

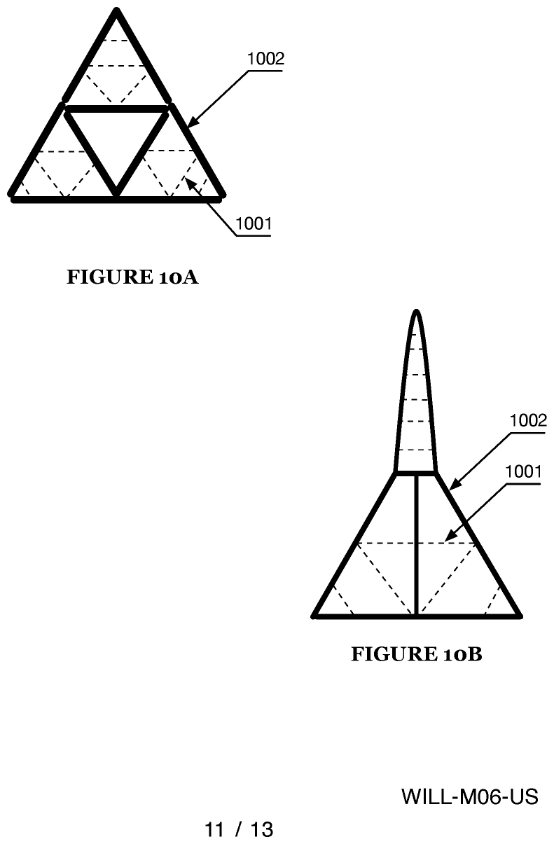

FIGS 10A and 10B are schematic representations of side profiles showing exemplary internal support walls in dashed lines promoting desired geometric forms;

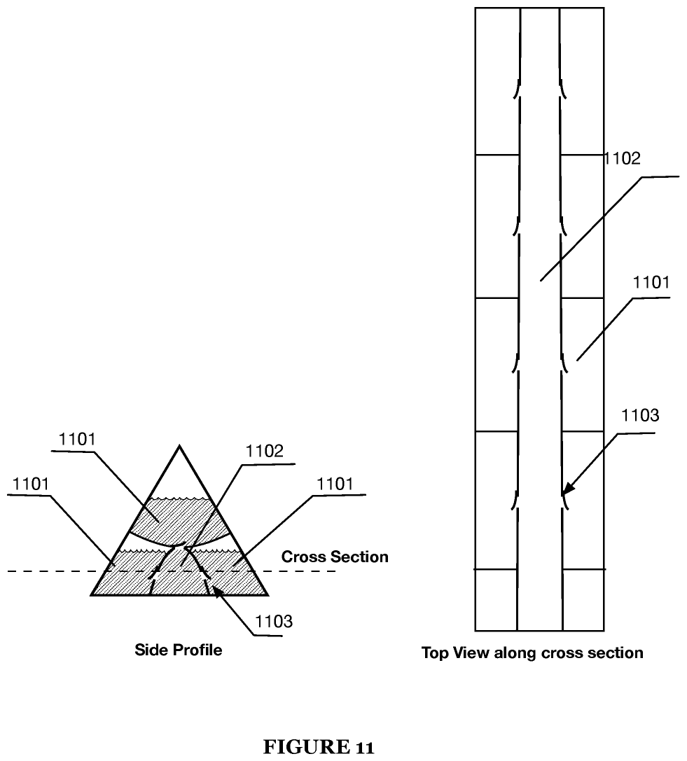

FIG. 11 is a diagram representation showing a side profile and corresponding top cross section across the length of a receptacle with a supply sub-channel and a set of reservoir sub-channels connected through one-way valve conduits;

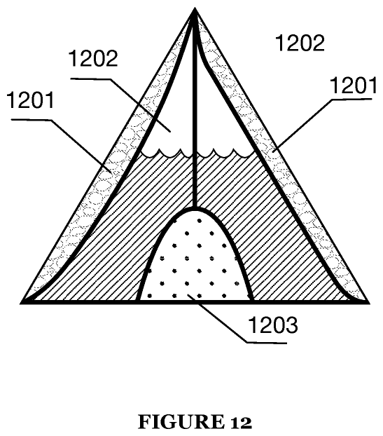

FIG. 12 is a schematic representation of a side profile of a receptacle with a fire retardant filled sub-channels, water-based filled sub-channels, and a gas-filled sub-channel; and

### DESCRIPTION OF THE EMBODIMENTS

The following description of the embodiments of the invention is not intended to limit the invention to these embodiments but rather to enable a person skilled in the art to make and use this invention.

### 1. Overview

A system and method for a deployable barrier that includes a portable tube-like (i.e., tubular) receptacle that may be expanded into a barrier by filling the tube-like receptacle with a filler material and/or installed as a permanent or semi-permanent barrier. The system and method function as a physical barrier usable in emergency situations and other applications. In preferred variations, the barrier of the system and method further functions to ease installation and deployment of a barrier. Variations of the system may be configured or designed for on-demand deployment and/or longer-term extended installation (e.g., 1-2 months or 1+ years). The system and method may be particularly useful as a fire containment barrier that can be both a physical and optionally chemical fire deterrent. The deployable barriers are preferably used to establish long paths or segments of firebreaks. When used as a fire mitigation tool for wildfires, the deployable barrier can preferably prevent, slow, and/or otherwise enhance the containment of a fire.

As a physical barrier, the deployable barrier of the system and method functions to establish a physical structure that disrupts the path of an advancing fire. The physical barrier can be established vertically wherein a fire would have to travel over the barrier. The physical barrier may additionally or alternatively be established horizontally where the barrier increases the surface distance between the two sides of the receptacle.

Variations of the system and method may additionally enable forms of chemical fire deterrent, wherein various fire retardant substances may be used to further suppress a wildfire.

In some preferred variations, the physical barrier has a deployed structural form that differs from an initial collapsed structural form. Preferably, the deployable barrier has a storage structural form where the receptacle is folded into a collapsed and compressed configuration such that it can be easily deployed along a length of a surface. The collapsed configuration will preferably be the state prior to filler material is added into the receptacle. For example, sections of the receptacle may be provided in a roll that can be unrolled along long lengths. When deployed, filler material is added to the receptacles and the receptacles expand into a deployed structure. In some variations, the deployed configuration is employed at the time of high fire risk. In other variations, the deployed configuration may be employed once the receptacles are positioned in the field. In some variations, the receptacle may house a portion of filler material while in the compressed configuration. For example, reactive filler material that expands when exposed to a catalyst filler material may be integrated, embedded, or otherwise housed in the receptacle during manufacturing.

In one preferred variation, a plastic tube receptacle is filled with a filler material such as water or a fire retardant substance. As a fire approaches, the filler material within the receptacle can heat up as it absorbs the thermal energy. To some degree, that heat will be conducted away through the filler material. If the fire gets in proximity to the receptacle and the outer layers of the receptacle reaches critical temperature, the plastic tube will burst or otherwise be penetrated and the filler material would naturally be distributed through the created opening—preferably directing a fire preventive filler material to a point of the advancing fire. More specifically, when the fire comes closer, the liquid will not be able to conduct away heat fast enough and the liquid will eventually begin to boil. Once that happens, the wall of the plastic tube will be permitted to exceed the boiling point of liquid and eventually exceed the melting point of the plastic enclosure. At that moment, the tube will preferably burst and release liquid at the rupture. The obvious advantage is that the liquid contents of the tube will naturally be released at exactly the point it is most needed, the tip of the advancing fire as it seeks to cross the barrier.

The system and method are primarily described as it may be applied and enhanced for fire mitigation (e.g., slowing or preventing the spread of ground fire). However, the system and method may alternatively be implemented as a water barrier, landslide barrier, or any other desired type of barrier. The compact storage and ability to quickly fill a volume can make the physical barriers of the system and method particularly useful in emergency situations. For example, in the case of flood mitigation, the system and method may be used to expedite the process of creating floor barriers. During floods, temporary water barriers are traditionally built from sandbags. Flood barriers created in part through the system and method may greatly increase the rate of adding volume to a flood barrier. For example, the system can be used to fill one or more receptacles with a filler substance, while sandbags and/or other mass materials can be built around the receptacle. In one exemplary use, the deployed receptacle filled with the filler material can act as the core structure. Sandbags or other materials can be layered on top. This can significantly decrease the amount of manual labor to build a water barrier. As water can be in ready supply during a flood, filling the receptacles could be performed by pumping from nearby water sources. As another potential benefit, the system and method could form a water impenetrable surface to the potentially better redirect and contain encroaching water.

The receptacle may have complex geometries to increase the stability of the barrier, and to provide an improved height; wherein the improved height reduces the likelihood of fires, or other substance, from crossing the barrier while requiring less filler material as compared to a circular tube-like barrier. Additionally the barrier may comprise multiple layers, providing potential insulation layers to further increase the heat resistance of the barrier.

The deployable barrier may be implemented as either a quick deploy barrier or a long-term prevention barrier. As a quick deploy barrier, the barrier can be relatively lightweight and compact such that it can be easily carried and/or transported to a desired location. It can then be quickly filled with filler material to deploy the barrier for a rapid response. As a long-term prevention barrier, the barrier may have a more durable and less weight oriented implementation. In addition to expanding the receptacle into a physical barrier, the filler material may additionally function as a chemical retardant that can be released by the deployable barrier in response to heat and fire.

The system and method may additionally incorporate supplementary components to facilitate monitoring the state of the deployed barrier and/or to facilitate deploying or maintaining the barrier (when in a deployed mode and/or when in a static compressed mode).

The system and method may provide a number of potential benefits. The system and method are not limited to always providing such benefits, and are presented only as exemplary representations for how the system and method may be put to use. The list of benefits is not intended to be exhaustive and other benefits may additionally or alternatively exist.

As one potential benefit, the containment barrier of the system and method can preferably mitigate the spread of fire and may provide one or more fire preventative measures that may serve to reduce or slow fire advancement. The filler material in some variations can provide a form of thermal dissipation to help disperse heat along the along of the barrier. The barrier can provide a physical barrier that can slow, halt, or even prevent the spread of a wildfire. As another example, the barrier may have fire-extinguishing features. In one example, a fluid filler material will be dispensed at a point where fire causes a rupture in region of the barrier. In another related example, active fire retardant substances may be dispensed in response to an approaching fire

As mentioned, a deployable barrier of the system and method may also be used for other applications, in which case it will preferably provide various potential benefits to those specific applications such as construction of water barriers and redirecting water in flood applications.

As another potential benefit, the system and method can be an economical way of forming a barrier. The human labor involved in deploying or setting up a deployable barrier can be low as workers are required for placing the barrier which in some implementations may be as simple as unrolling as the worker(s) moving along the desired path of the barrier. Additional the raw materials and manufacturing processes involved in creating the receptacles can be done at scale to drive down cost.

As another potential benefit, the system and method may be quickly deployed to form a barrier. The quick deployment may enable rapid response to a fire that may provide critically needed aid when necessary. Compared to traditional firebreaks that require time consuming and labor-intensive clearing of ground covering, the system and method can enable a firebreak to deployed on demand. Preferably, the deployment additionally relies on few human workers. As discussed herein, such a quickly deployed barrier can have applications beyond fire mitigation such as forming flood barrier walls and/or other types of barriers.

The economical solution and quick deployment of the system and method has obvious cost saving and feasibility benefits, but as a tool for emergency relief, this may also translate to significantly more preventive measures that can be put into place, which can reduce damage and save lives and property. For example, since the deployable barrier may be relatively cheap and easy to deploy, that means it can also be used more widely. Instead of installing a single line of a firebreak, multiple lines of firebreaks can be installed.

Another potential benefit of the system and method is that the barrier may be implemented to utilize “local” material (e.g. soil) to fill the barrier. This may further improve the portability and deployability of the barrier, wherein transportation of tons of filler material may not be necessary.

Another potential benefit of the system and method is the barrier portability. The barrier portability can enable utilization of the barrier in regions where a firebreak or barrier may not typically be implemented due to difficulty, e.g. dense or remote forests. Furthermore, the system and method can create a firebreak with more flexibility in its shape and form. Related to the possibility of quick deployment, the layout of the firebreak may additionally be customized to the current fire conditions, which may improve the effectiveness of the firebreak.

In some cases, traditional firebreaks may need to be regularly maintained in very rural and wilderness areas, where natural growth can quickly take over and basically negate the firebreak. Another potential benefit of the system and method is that a durable barrier in these regions would potentially require much less maintenance while still providing adequate fire protection.

The system and method may have particular applicability for fire containment. The system and method may be useful for professional firefighting application and for private individuals to protect certain areas, such as homes. The system and method may have additional or alternative applications to rural or mixed environments. The system and method may be used to safeguard homes, neighborhoods, various infrastructure sites, and the like. The system and method may additionally be used in other settings requiring a barrier, for example, as a deployable damn or other water barrier.

### 2. System

As shown in FIG. 1, a system for a deployable barrier can include a receptacle 110 that includes a set of walls that are at least partially made of a flexible material and that define at least one sub-channel extending along a length of the receptacle and a filler material 120 that when introduced into the at least one sub-channel expands the receptacle into a deployed configuration and thereby forming a barrier with an expanded form. The receptacle preferably includes an inlet to the at least one sub-channel through which filler material 120 is introduced. Additionally, the receptacle can be arranged in a collapsed configuration or configurations as shown in the exemplary receptacle of FIGS. 6A and 6B, wherein the receptacle preferably is initially supplied or positioned when in a collapsed configuration and then transitions to a deployed configuration forming a barrier. The receptacle expands into the deployed configuration as shown in FIG. 6C when a sub-channel is filled with filler material 11

The system can be used for a fire mitigation barrier deployed along a surface (e.g., ground surface). The deployable barrier created by the system may function as a barrier that reduces likelihood of a fire crossing from one side of the barrier to the other side. As a fire barrier, the deployable barrier may function as a physical barrier, i.e. a heat resistant physical obstacle to an advancing fire. Additionally and/or alternatively, the deployable barrier may function as an environmental aid barrier, i.e. increasing the heat resistance and/or fire resistance of flammable objects in proximity of the quick deploy barrier. The system can alternatively be used for a water containment or diversion barrier, landmass debris barrier, or other suitable types of barriers.

The deployable barrier may be implemented either as a quick deploy on-demand barrier that can be responsively installed or as a long-term prevention barrier that may be permanently or semi-permanently installed in preparation for a possible fie. Although these two implementations may be structurally similar in many respects, the quick deploy barrier may have structural differences to maximize barrier portability and quick implementation, while the long-term prevention barrier may have material and structural differences to maximize barrier durability. Variations described here may be suitably applied to either of these uses.

In variations directed towards on-demand deployment (e.g. in response to a current fire), the deployable barrier may have many desirable quick deploy attributes. In one example, the non-activated form factor could be substantially compact for storage and handling reasons. In another example, positioning and physical placement of the physical barrier prior to activation may involve unrolling the non-activated barrier into position, which could be performed quickly and require a single person, or a small team of workers. In a third example, activation of the barrier could similarly be fast by filling the deployable barrier with the filler substance. That is, the filler material 120 may be a “quickly deployable” substance that is used to quickly fill the deployable barrier 110. As an on-demand implementation, the deployable barrier could be deployed in response to the quickly changing conditions (e.g. during a wildfire, flood, or changing weather conditions).

In variations directed towards a long-term prevention barrier, the deployable barrier 110 preferably shares similar desirable attributes as well as other specific attributes to its longer term of use. In one example, the installation of a preemptive long-term prevention barrier prior to a fire could similarly be more easily achieved than clearing a wide stretch of a forest. In this example, a long-term prevention barrier may be implemented between larger foliage (e.g. trees), while requiring some clearing of smaller foliage (e.g. leaves, bushes, shrubs) during the implementation process. In addition to providing an actual barrier itself, this example may additionally clear a wider stretch of forest over time by “dispersing” gathering foliage further apart on either side of the barrier, thereby further improving the efficacy of the fire barrier. The long-term prevention barrier may be a deployable barrier 110 that functions at a reduced cost and reduced amount of installation labor, as compared to other barriers and may be installed in more regions making fire prone regions better prepared against fires.

The receptacle 110 of a preferred embodiment functions as the body of the deployable barrier that contains and/or transports the filler material 120. The tube-like receptacle may 110 be in an undeployed collapsed configuration, that when filled with the filler-substance 120, expands into a deployed configuration to function as the active barrier. The receptacle 110 when expanded into the deployed configuration preferably functions as a fire barrier, but may additionally or alternatively function as other types of barrier. For example, the receptacle may 110 be used as a dam or other type of water barrier, landslide barrier, erosion barrier, or other forms of physical barriers.

There are many various implementations of the receptacle 110 using one or more of the variations described herein. Any of the variations may be used in any suitable combination. Furthermore, in some implementations different types of receptacle segments can be used at different points. For example, one portion where fire risk is low may be optimized for transport of filler material 120, while segments in high fire risk areas may use receptacle segments for more fire preventative measures. As such, the system may comprise of a first type of receptacle 110 comprising of a first set of features or elements such as in variations described herein and at least a second type of receptacle comprising of a second set of features or elements such as in the variations described herein.

In a general preferred variation, the receptacle 110 is can be made of a flexible material such as extruded tubular sheets of plastic. The receptacle 110 preferably is initially set into a collapsed configuration for condensing form factor and has deployed stated with a different geometry for use as a barrier. The material is preferably manufactured into longitudinal or lengths of a receptacle 110 so that it can be set in place along some path on a surface (e.g., the ground). The receptacle 110 preferably includes at least an outer surface with a defined internal cavity with at least one exposed opening. More preferably, the receptacles 110 includes a defined through channel running along its length. More specifically, the receptacle 110 can include two exposed openings of the defined cavity forming a through channel. Some variations, as described herein, may include internal walls or structures defining sub channel reservoirs, flow control mechanisms, material holding structures, and/or other features. As other features, the receptacle 110 may additionally include embedded material integrated into the receptacle prior to adding of filler material 120; connectors to couple two or more adjacent receptacles 110 with at least temporary connected flow of filler material 120 between the adjacent receptacles 110.

The receptacle 110 can preferably be a device manufactured in long lengths. Herein, the direction along the main length is referred to as the length of the receptacle no. The shape of the receptacle perpendicular or transverse to the length is referred to as the side profile. Many variations can be implemented through cost effective and scalable manufacturing techniques. In some preferred implementations, the core structure of the receptacle (e.g., the external and internal walls) may be manufactured as extruded forms enabling long lengths of the receptacle 120 to be manufactured. Additional manufacturing techniques such as applied cutting, perforation, etching or other manufactured openings may be selectively applied to form various features or elements. Furthermore, sealing, adhesives, clamps or other fixture devices, may additionally be used. In some variations, embedded materials or rigid elements can be coupled, adhered, or otherwise integrated into the material and structures of the receptacle no. While some implementations of the receptacle 110 may have the main body of the receptacle 110 be formed from flexible material, some variations may include embedded rigid elements that can be coupled, adhered, or otherwise integrated into the material of the receptacle 110.

To enable the system can be easily stored in preparation for use and/or for ease of installing and setting up the device, the receptacle 110 preferably has an initial collapsed configuration and at least one deployed configuration. A collapsed configuration preferably characterizes an arrangement of the receptacle 110 and attached components prior to adding the filler material 120. A deployed configuration, which may alternatively be described as an expanded configuration, is an arrangement of the receptacle 110 where at least a portion of the receptacle is expanded in response to a defined cavity containing an introduced filler material 120. The volume within the outer surface of the receptacle when in a collapsed configuration will preferably be less than the volume within the outer surface of the receptacle when in a deployed configuration. In some implementations, the packed receptacle takes up less than multiple orders of magnitude volume as compared to receptacle in the expanded state.

In practice, the system may transition between multiple configurations or stages of deployment. In one exemplary implementation, a length of a receptacle is supplied in a roll of a flattened arrangement, the receptacle can be unrolled when positioning on the ground; while on the ground, the receptacle can be left in a flat arrangement for some duration; and in response to the introduction of filler material 120 into the internal defined channels in the receptacle, the receptacle expands to a deployed configuration. In some variations, there may be multiple stages of deployed configuration which could depend on how much filler material 120 is added; which channels have filler material 120 added if there are multiple channels; and/or other control aspects.

When in the collapsed configuration, the tube maybe compressed or packed (e.g. by folding or rolling) into a compact body that takes up significantly less space than the expanded receptacle 110. Preferably, the collapsed configuration of the receptacle 110 will include an arrangement of the receptacle with a collapsed profile and folded across its length for more compact storage and ease of installation.

The receptacle 110 when in a collapsed configuration is preferably folded along an axis defined along the length of the receptacle. More preferably a series of folds arrange the receptacle side profile of the receptacle into a substantially flat rectangular profile as shown in FIGS. 6B and 9B. A flat rectangular profile will generally have an aspect ratio of width to height is very high. For example, the width to height aspect ratio may be 10 to 1 in some implementations or even 100 to 1. The external and/or the internal wall surfaces may be formed with width profiles to promote folding along desired seam lines along its length. Additionally or alternatively, the internal or external walls may be biased during manufacture for collapsing across its profile in a desired pattern.

Preferably, the receptacle 110 may additionally be collapsed in a way that compresses or organizes the length of the receptacle 110. Accordingly, the receptacle no may additionally be folded across the defined length axis. In other words, the receptacle 110 when in a collapsed configuration may be folded transverse to the length axis. The folding may be implemented as rolling of the receptacle 110 as a version of continuous folding as shown in FIG. 6A and 9A. The folding may alternatively be periodic folding. For example, the transverse folding can be a back and forth folded arrangement of the receptacle 110. The transverse folding is preferably arranged for ease of dispensing of the receptacle from at least one end. For example, when the receptacle 110 is in its original collapsed state (profile collapsed to a flat rectangular profile and transverse folding for bundling the receptacle) the receptacle 110 can be installed by pulling and “unfolding” the receptacle 110 length-wise.

The receptacle 110 when in a deployed configuration preferably has at least a portion of internal cavities filled with filler material 120. More preferably, substantially all of at least one internal cavity is filled or to a filled level (e.g., majority filled) with filler material 120. In some implementations, there may be some internal cavities (bordered by walls of the receptacle 110) that may be kept in a collapsed configuration until a later point such as defined cavities that are backup channels that are used if an initially deployed channel fails. When deployed, the receptacle 110 preferably takes on a form with a geometry that fills a larger volume.

The receptacle 110 can include a structural geometry or form in a deployed configuration with a portion of the receptacle extending above the supporting surface (e.g., the ground). The vertically extending form of the receptacle 110 when in a deployed configuration can function to create a physical barrier over which fire debris would have to travel. In one variation this vertically extending form may be an integral portion of the form of the deployed receptacle 110 such as when the receptacle expands to a circular, rectangular, or triangular tubular shape. In another variation, a vertically extending form may be an appended element intended to purposefully accentuate the height. For example, one variation may have one vertical extension sub-channel 701 positioned along the top of the receptacle that is extends predominately upwards as shown in FIG. 7. In this example, such a sub-channel may be filled with air or other material, as its primary purpose is a physical barrier.

The receptacle 110 may additionally or alternatively include a structural geometry or form in a deployed configuration with a portion of the receptacle extending horizontally across the supporting surface. The horizontally extending form of the receptacle 110 when in a deployed configuration can function to create a physical barrier between the two sides of the receptacle 110 when serving as a firebreak. In one variation, the receptacle 110 may be initially installed lengthwise and then the collapsed profile can expand so as to expand the horizontal base of the receptacle. As with the vertically extending form above, a horizontally extending form may be a central part of the geometry of the receptacle 110 design as shown in the exemplary design of FIGS 9A-9C where the expanded receptacle 110 rolls out lengthwise (e.g., transition between FIGS. 9A to 9B) and then unrolls/unfolds horizontally to make a wide and long barrier (e.g., transition between FIGS. 9B to 9C). The horizontally extending form may alternatively be an appended element that functions to purposefully accentuate the width and ground coverage of the receptacle when deployed. As shown in the exemplary design of FIG. 8, one or more sub-channels of the receptacle 110 may have a deployed form that extends predominately horizontally form the central form of the deployed receptacle 110.

The vertical and/or horizontally extending features can be referred generally as appendage features. These appendage features may be filled with alternative filler material 120 and in some cases may be filled with air when deployed. Additionally or alternatively, the appendage features may have embedded metal mesh or other heat conducting materials so that the heat can be thermally transmitted across the appendage.

In some variations, the receptacle 110 may have a non-circular geometry (e.g. triangular) once actively deployed, as shown in FIG. 3A and FIG. 4A. The non-circular geometry may be a general property of the receptacle no; that is the filled version of the receptacle is non-circular. Alternatively, the non-circular receptacle geometry may be due to the combination of multiple receptacles 110 arranged in complex geometries. Non-circular geometries may function to provide an improved barrier. Additionally, non-circular barriers may provide greater stability against moving sliding (e.g. rolling down a hill, or stability resistance when deployed as a water barrier for flooding).

In preferred variations, the receptacle 110 has a geometry that is taller than it is wide. That is, the height of the deployed receptacle 110 is preferably greater than the width. The height of the receptacle 110 may function to provide an improved barrier to prevent a fire from crossing. The “reduced” width of the receptacle 110 may function to reduce the required filler material 120 necessary to deploy the barrier. Various geometries may be used.

The receptacle 110 may be constructed of different materials depending on implementation. As mentioned previously, for a quick deploy implementation the receptacle may be constructed of material that can be made extra compact (e.g. soft plastics), while for a long-term prevention barrier implementation, the receptacle may be constructed of more durable material (e.g. synthetic fibers, leather). The walls of the receptacle 110 are preferably substantially thin to provide necessary flexibility for collapsing. Thickness can be dependent on the folding pattern and various features or operating parameters for the system.

In some variations, the receptacle 110 may be made up of multiple materials. In one variation, the outer walls of the receptacle 110 may have multiple layers of materials. For example, the outer wall of the receptacle 110 may have an internal layer and an external layer, where the external layer may be made of a more heat resistant material. In one variation, the outer wall of the receptacle 110 may have a reflective coating, which could be an applied treatment or a material. The reflective coating could function to reflect heat from an encroaching fire.

Additionally, internal walls may be made of different materials. For example, different channels may be made with wall material with different melting points depending on their intended purposes. If the second sub-channel is servicing as a filler material 120 supply conduit it may be made with a material with a higher melting point than a second sub-channel acting more as a local reservoir of filler material 120. If the second sub-channel is compromised and breaks, the supply conduit may not fail.

In some variations, the receptacle 110 may be composed of biodegradable material. This may be particularly the case for the long-term prevention use case. Biodegradable material may function to minimize the environmental impact of the deployable barrier. In these variations, biodegradable material may enable the barrier to be deployed in a “drop-and forget” manner; wherein the system may be proactively deployed over large regions of land, with minimal long-term environmental impact. For example, in particularly dry seasons or other times when the chances of a fire are likely; long-term prevention biodegradable barriers may be deployed proactively through key regions. These barriers may then be left in place to biodegrade over the span of years.

The receptacle 110 preferably has external walls defining at least one internal defined cavity. In many variations, the receptacle 110 comprises of a set of defined cavities (e.g., defined tubes, chambers, channels, or cavities) that may be filled with a filler material 120 during a deployed configuration. Herein, these defined cavities will be generally referred to as sub-channels of the receptacle 110. The receptacle 110 will preferably include at least one defined through channel extending through the length. A receptacle 110 may have one or more sub-channels. A set of internal walls connecting to the external walls or other internal walls may be used to reinforce a desired structural form during deployment and/or define various chambers or sub-channels. Sub-channels can be fully isolated from another sub-channel in that there are no conduits or paths for material to flow to another sub-channel. A sub-channel may alternatively have some conduits to other sub-channels. In some cases, such conduits may be through a valve that promotes filler material 120 entering a sub-channel from another sub-channel but not reentering the originating sub-channel.

As one variation, the sub-channels may be continuous channels along the entire length of the receptacle. Multiple channel regions therefore may function as redundant channels as shown in FIG. 2A. In another variation, different sub-channels may not be continuous channel but be a closed chamber that extends some length of the receptacle. In one variation, multiple closed chamber regions could be aligned along the length of the receptacle as shown in FIG. 2B. As another variation, multiple sub-channels could be staggered along the length of the receptacle as shown in FIG. 2C.

Each sub-channel of the receptacle 110 could serve the same or a different functional purpose. For a fire barrier example, multiple sub-channels may serve the single function of expanding into a physical barrier, wherein expanding distinct sub-channels may create a physical barrier of different shapes (e.g., different sub-channels of the receptacle 110 may be filled to expand the receptacle into a linear fire barrier and/or to expand the receptacle into an L-shaped fire barrier). In an example demonstrating distinct functioning sub-channels, one sub-channel of may function to expand the receptacle into the physical fire barrier and another sub-channel of the receptacle 110 may be for the release of flame retardant during a fire.

The geometry of the sub-channels can be varied. As some example geometries, a sub-channel may be large open channels, a thin open layer, small chambers with a length significantly shorter than the length of the receptacle (e.g., 10 to 100+ times smaller length), and/or other configurations. The arrangement of the sub-channel position relative to the other sub-channels within the general side-profile of the receptacle can also be another variable in altering the function or purpose of the sub-channel. The filler material 120 used to fill a particular sub-channel may also be another variable.

A sub-channel may be a through channel, where a through channel includes at least two openings where filler material 120 can flow in through at least one inlet and flow out through at least one outlet. In some variations, normal direction of flow may be incorporated into the design and reference to inlet and outlet implies inlet being a defined opening through which filler material 120 is received and outlet being a defined opening through which filler material 120 exits. In some variations, flow may happen in both directions and therefore openings may operate as inlets or outlets depending on current use and conditions.

In some variations, a sub-channel may be a contained reservoir with only inlets such that material comes in but preferably does not flow out under normal conditions.

The internal walls preferably extend length-wise down the length of the receptacle 110 when used in forming a sub-channel. In some variations, internal walls may not be continuous lengthwise. For example, a set of internal walls may extend lengthwise for some length and then converge to terminate the sub-channel, which may be used in making the sub-channel a reservoir for holding filler material 120. Some internal walls may be defined transverse to the defined length axis. For example, transverse internal walls may section off regions or sub-channels.

Sub-channels may be used in a variety of ways. A set of sub-channels may include one or more reservoir sub-channels that preferably have at least one inlet and preferably no outlets so that they can be filled and then stay filled until an event causes a rupture.

The set of sub-channels may include may be one or more supply sub-channels that function to be a main channel for supplying filler material 120 down a length of receptacle(s) 110. A supply sub-channel preferably has an inlet where filler material 120 is supplied. Supply sub-channels will additionally preferably run through the length of the receptacle 110 and may be coupled to a supply sub-channel of one or more connected receptacles 110. The supply sub-channel can additionally include a set of outlets into connected sub-channels. These sub-channels may be other through channels but could also be reservoir sub-channels or other types of sub-channels. As one variation, there may be a redundant supply sub-channel that can be used in the event an initial supply sub-channel one fails.

The set of sub-channels may include one or more material embedded sub-channels. A material embed sub-channel may have additives that may serve to react to an introduced filler material 120, supplement a filler material 120, react to exposure to the environment (e.g., if the surrounding walls are breached), and/or react to presence of heat or fire. The material in one variation acts as a chemical fire retardant. The material in another variation may act as a volume expanding. For example, a hydrophobic foam material (e.g., hydrophilic polyurethane foam) may react to introduced water to expand and fill a sub-chamber thereby more efficiently filling a volume. Any type of sub-channel may also be a material embedded sub-channel. In some variations, all sub-channels have embedded materials.

In some implementations, the deployable barrier may be configured to regulate/meter the rate that the filler material 120 flows through or out of a tube. In one variation, in-line obstructions may be introduced within the internal cavity of the tube. For example an internally protruding structure inside a region of tube slowing the flow of filler in the tube. In another variation, the tube may be formed into a serpentine or meandering pattern to slow the flow of filler as shown in FIG. 2D.

As another variation, the tubes may have internally formed valves to limit or control flow in one direction. The valves may be configured to be one directional. The valves may also be omnidirectional but set to open for certain pressure levels, which functions to allow filler to flow between chambers only under certain pressure conditions. Multiple internal valves formed within the tube will function to form multiple sub-chambers. In one preferred variation, a rupture in one sub-chamber will preferably not draw filler from sub-chambers down the line of the tube, but the one chamber could still have filler supplied to it from one side of the channel. In the case of multiple redundant channels, one subset of channels may include a set of valves distributed across its length and oriented in a first direction, and a second subset of channels may include a set of valves distributed across its length and oriented in a second/opposite direction as shown in FIG. 2E. In this way sub chambers of the channel can be filled from either direction.

In another variation, the tubes may form multiple layers. These multiple layers may provide additional insulation layers that further increase the heat resistance of the deployed barrier. Additionally, the multiple insulation layers may reduce the amount of required filler material 120 to deploy the barrier. For example, as shown in FIG. 3B and FIG. 4B, the receptacle 110 may include an external layer filled with one filler material 120 (e.g. flame retardant), and an internal layer filled with another filler material 120 (e.g. air). The external sub-channel filled with flame retardant may serve as an external fire deterrent if an external wall is breached. The internal sub-channel filled with air may serve as providing volume and geometric form. In another variation, one or more sub-channels filled with water surrounding the air sub-channel and adjacent to the flame retardant sub-channels can serve to act as conduit for thermal dissipation along the length of the receptacle 110. In some variations, the deployed barrier may comprise multiple tube layers, wherein some layers may comprise of insulation layers filled preferably with air, but alternatively with another insulating filler material 120.

The receptacle 110 may additionally have specific material properties. These specific material properties may/or may not be associated with different sub channels of the receptacle. In one variation of the fire barrier receptacle 110 may be designed to open or explode at or near regions experiencing thermal conditions once a certain heat threshold is reached, releasing the inner content of the receptacle on the nearby surroundings. Alternatively for a receptacle 110 with multiple sub-channels, one sub-channel may explode beyond a certain heat threshold, while other sub-channels are heat resistant and maintains structural integrity under heat. In this example some sub-channels may function as a physical barrier, while other sub-channels function as a chemical barrier by releasing chemical retardant filler material 120 in proximity of the deployable barrier.

The material patterning could additionally be integrated into the material make up of the receptacle. For example, one may prefer many smaller ruptures to disperse the water rather than one large one. The goal might be to retain some of the shape of the tube when the main casing ruptures, or it might be to produce a spraying effect to better disperse the water above ground. In either case a coarse woven mesh, may be embedded into the plastic. Something like fiberglass with 0.25″ holes would preferably melt much later than the plastic, so a rupture in the plastic would leave the mesh in tack to reduce the size of an initial opening, slow the initial flow of water out of it, and convert the water pressure into water velocity to disperse it more widely. In another variation, the a pattern of defined regions with thinner wall thickness could be dispersed along the outer wall. The defined regions will generally be small circular regions where ruptures could result in dispersing filler material 120 in a stream. In another variation, an outer coating of fire resistance material could be layered on the out surface of the receptacle with defined open regions lacking the coating. These defined regions could similarly be small circular regions so that when that region breaks down filler material 120 is dispersed through the openings of the outer resistance material.

The receptacle 110 may have other properties. In some implementations parts of, or the entire, receptacle 110 may have a semi-porous structure. For example, one fill region of the receptacle 110 may have a porous structure, such that under high levels of heat and pressure, the filler material 120 from that one region may spray out, or slowly released, from the expanded receptacle 110. In one variation, the receptacle 110 may comprise a solid (i.e. non-porous) and a porous region. For example, in this variation, the receptacle 110 may be filled with both normal water and high-pressure water as filler-substance. The normal water may give the receptacle structure in the solid region and at high temperatures the high-pressure water may be sprayed out as water mist through from the porous region.

In one variation, the receptacle may include self-healing mechanisms such that small punctures or breaks in a tube can be resealed under normal, non-fire conditions. In one variation, the filler material 120 may include a substance that will reseal a puncture in the material of the receptacle. As a related variation, the system may include a rupture detection system that monitors filler material 120 status and in detecting a release of filler material 120 can dynamically release resealing filler, which will ideally reseal the puncture. The rupture detection system preferably can access fire data so that the resealing filler is not released if fire conditions are present or likely. In another variation, the material of the receptacle can include self-healing properties. For example, a self-healing rubber or a layer of self-healing rubber could be used within the receptacle. As the self-healing and resealing mechanisms will likely not be resilient to an advancing fire, the system will still operate as desired when encountering a fire. However, the self-healing mechanism may function to make the deployable barrier resilient to wear and tear while in the field or during deployment.

The receptacle 110 preferably includes at least one inlet. In the simple case, this would be an open side of the receptacle 110 wherein one or more regions can be filled, and then the receptacle sealed in some manner such as mechanical clamp/seal, heat sealing material, chemically sealing (e.g., gluing), and the like. In another variation, an inlet mechanism could be integrated into the receptacle such that filler material 120 can be added and then the inlet closed. The inlet may include a valve to prevent or mitigate flow of filler out of the inlet. In one variation, an inlet is present on at least one end of the receptacle. In another variation, inlets may be integrated periodically in the receptacle. A given region (e.g., chamber or channel) may have one or more inlets. One preferred form factor of the receptacle when in a collapsed mode is a collapsed roll. Accordingly, the inlets may be aligned along a fold seam of the receptacle such that the inlets extend outward from the reel and do not obstruct rolling the receptacle. Alternatively, the inlets could be made as substantially flat inlets such that they do not obstruct rolling the collapsed form of the receptacle.

The system may additionally or alternatively include a supply hose, which functions to supply filler material to one or more inlets. The supply hose preferably connects to at a series of inlets. The supply hose can be a robust fire resistant hose. When installing the system, the supply hose can be laid out along with the receptacle. The hose can be used to supply the filler material when it's time for the receptacle 110 to deploy. In one implementation, the hose is intended to be stored underneath the receptacle so as to be further protected from fire. The supply hose may be a separate component coupled to the inlet connectors of the receptacle 110. The supply hose may alternatively be attached to the receptacle so that it is provided as a single integrated system. In one variation, the supply hose could be a standard hose that connects to a standard hose connector on either end. Alternatively, a custom supply hose could have multiple outlets along its length such that the supply hose can supply filler material 120 at multiple points.

The system may additionally include one or more variations of receptacle interconnects or connectors. A connection interconnect can allow lengths of receptacles 110 to be connected to form a barrier that is longer length. A branch connection interconnect can allow three or more deployable barriers or other inlets/outlets to be connected. In some instances, the interconnects can have integrated physical valves. The interconnects can additionally have sub-channels such that sub-channels of the receptacles are appropriately coupled to the sub-channels of a connected receptacle. The interconnects may be integrated directly into the receptacle structure during manufacturing. The interconnects of two receptacles may be mechanically coupled. Alternatively a bridge connector may be used in combining to the connectors of two receptacles. Alternatively, interconnects may be used during installation of the receptacles.

In some variations, the interconnects may include valves. The valves may be passive valves. For example, a one-directional valve may enable flow of filler material 120 in one direction but prevent or mitigate the flow in the opposite direction. In another variation, the interconnect system could include a dynamic electronically controlled system where valves can be dynamically changed. This may be used to shut off flow, which be used if a connected receptacle is compromised. A dynamic electronically controlled valve system may additionally or alternatively redirect flow between different sub-channels. For example, the flow of filler material 120 may be appropriately directed between different supply sub-channels based on which supply sub-channel is active for a given receptacle. For example, if an initial supply sub-channel is compromised during a fire, the dynamic valve could redirect inbound filler material 120 from a connected supply sub-channel to a backup supply sub-channel so that filler material 120 can continue to flow down stream.

Additionally or alternatively, an interconnect can include one or more sensing systems and a communication device to monitor the status of a barrier and communicate this information to a remote computer system. The communication device can be a cellular communication module, an RF signal transmitter, and/or any suitable communication device. The sensor may sense flow rates, pressure, temperatures, and/or other parameters.

Connection interconnects may additionally enable replacing receptacles 110 over time to maintain barrier functionality. Sections of the deployed barrier may be removed (e.g. by disconnecting or cutting) and new tubing may be added as desired. In addition to providing a possibility for barrier maintenance, replacement tubing may enable modifying the shape deployed barrier and potentially deploying tubing with improved filler that was not initially available.

The filler material 120 of a preferred embodiment is a material that is injected, pumped or otherwise introduced into the receptacle. The filler material 120 may have multiple functionalities, wherein at least one functionality of the filler material 120 is to expand the receptacle into a barrier. In preferable variations, the filler material 120 is a non-solid material (e.g. gaseous, aqueous), but may alternatively be a solid, a solid-like material (e.g. glass phase), or a material that undergoes a phase transition into a solid at some point (e.g. a liquid converted to a solid foam once injected into the receptacle 110). The filler material 120 may comprise of a single compound or multiple compounds (e.g. water, and flame retardant foam). Examples of filler substances 120 include: water, air, monoammonium phosphate, sodium bicarbonate, potassium bicarbonate, potassium bicarbonat and urea complex, potassium chloride, foam-compatible (sodium bicarbonate based dry chemical), MET-L-KYL/PYROKYL, aqueous film-forming foam, alcohol-resistant aqueous film-forming foams, film-forming fluoroprotein, Arctic Fire, FireAde, Cold Fire, antifreeze chemicals, Loaded Stream, Halon, Halocarbon replacements, carbon dioxide, Novec1230 fluid, potassium aerosol particle-generator, E-36 Cryotec. Other suitable substances or combinations of substances may alternatively be used.

Generally speaking, filler material 120 may comprise of any compound (or compounds) that can add volume structure and/or has flame retardant properties. Preferably, a filler material 120 is chosen to minimize the weight to volume ratio of the filler substance. The filler material 120 may have additional properties as desired and by implementation. For example, the filler material 120 utilized in the wilderness may be chosen for minimal environmental impact (e.g. water), while the filler material 120 for a city fire may be chosen for maximal flame retardant capability (e.g. a wet foam).

In some preferred variations, the filler material 120 is comprised of water or a water-based fluid. Water may be the only filler material 120 or one of multiple compounds. Water, as referred herein, may be any primarily hydrogen dioxide based compound (including different ionic states, different metal concentrations), in any state (e.g. solid, liquid, gas), under any type of thermodynamic “condition” (e.g. pressure, temperature). For example, water may be implemented as a filler compound 120 in multiple states for multiple reasons: In one implementation the filler material 120 may be “normal” liquid water to give the barrier physical integrity, while another implementation may utilize high pressure water that would be released as water mist at high temperatures as a flame retardant.

In some variations, the filler material 120 may comprise of a foam (or multiple foams). The foam filler material 120 is preferably a flame retardant liquid foam, but may alternatively be other types of liquid foams. In one alternative variation the filler material 120 is first pumped into the receptacle and then converted to a liquid or solid foam through a chemical reaction.

In some variations, a gas may be used as a filler material 120 for a sub-channel of a receptacle 110. The gas could be normal air pumped into the sub-channel. An air filled sub-channel is preferably used in an implementation with a plurality of sub-channels or additional channels, wherein the gas filled sub-channel can function to add volume.

In another variation, the filler material 120 may at least partially comprise organic material (e.g. earth, soil). Organic material may function as a locally available filler material 120 that enables efficient deployment of the system in difficult access regions (e.g. dense forest). In this manner, the organic material may serve to fill the receptacle 110 in regions where it may not be possible to use other filler substances 120. Preferably the organic material comprises at least the majority volume of the filler material 120, but may alternatively have a lesser volume. In this variation the filler material 120 may completely comprise organic material or may only partially comprise the organic material.

In some preferred implementations the filler material 120 may additionally include additives that alter the general state properties of the organic material. These additives may function to change any general state or functional properties of the organic material as desired. In one preferred example, the additive includes a retardant. In addition to the prior exposition of retardants, retardants may function to reduce the flammability of potentially flammable filler material 120 organic material (e.g. leaves, branches). In another preferred example, the additive may include a substance to alter the state of the organic material. Chemical additives may be added to the organic material to at least partially convert the organic material into a different state. In one implementation, additives may be added to the organic material (e.g. soil) to extract carbon dioxide. Carbon dioxide extracted in this manner may function as an additional insulation and/or also the major volume of a fully deployed barrier, enabling faster deployment. In a second implementation, additives may be added to the organic material (e.g. soil or foliage) to extract foam compounds from the organic material. These foam compounds may additionally provide greater volume to the filler material 120 and/or provide an additional flame retardant.

Dependent on the type of implementation, the filler material 120 may be chosen for the level of biodegradability. For example, in easily accessible regions, the filler material 120 may be chosen to maximize fire prevention. In another example, in an environmentally sensitive region, the filler material 120 may be chosen for its capability to break down over time, with minimal environmental impact.

In some variations, the filler material 120 may include repair filler additives. Repair filler additives may function to improve the puncture resistance of the receptacle and/or “reseal” punctures that occur in the receptacle.

In many variations, the system may include additional components such as a reservoir system, deployment tools, status sensors, and/or other components

The system may additionally include reservoir systems, which function to passively or actively regulate deployment of a filler material 120. A passive reservoir system is preferably a gravity or pressure based reservoir of filler that can be coupled to the deployable barrier. An active reservoir system may control deployment of filler material 120 based on a control system. The control system may operate based on sensed conditions of the collapsed barrier, data sources on weather or fire conditions, an administrator control system, and/or any suitable input.

The system may additionally include deployment tools that function to facilitate deployment of the deployable barrier. For example, a receptacle reel structure may hold a roll of collapsed receptacle. The receptacle reel may assist when deploying the reel. In one variation, the receptacle reel may be motorized and configured to rotate and unroll the deployable barrier according to ground speed of the receptacle reel. This can function so that the deployable barrier can be automatically deployed from a moving vehicle without dragging of the barrier. In this way a car outfitted with the automatic reel could drive around an urban setting while letting out the barrier. Automatic deployment may additionally enable airdrop deployment of the deployable barrier (e.g. from a helicopter). The barrier may fully be deployed in the air, or may alternatively be dropped, and then deployed during the drop, or once the barrier has landed.

Status sensors may monitor the state of a receptacle, portions of a receptacle or a plurality of receptacles. Status sensors may include temperature sensors. The status sensors may additionally include filler material level, flow, pressure, filler material temperature sensors, and/or other sensors. The status sensors can be connected to an energy storage system such as a long-term batter, solar power system or the like. The status sensors additionally connect to a communication module that can relay data wirelessly or wired to a computing system that can analyze the data. The data may be used to alter control of the system. Control of the system may be exerted through controlling the supply of the filler material (rate, material type, etc.). Control may also be selecting which sub-channels to deploy or undeploy.

The various features described above may be combined in any suitable combination. Furthermore, such features may be applied to a variety of use cases where deployable barrier may be useful.

As a detailed description of various preferred implementations employing variations of a system described above for a fire mitigation barrier deployed along a surface, the system may include: a receptacle that is at least partially made of a flexible material that defines a sub-channel extending along a length of the receptacle, and the receptacle comprising an inlet to the at least one sub-channel; wherein the receptacle can be arranged in a collapsed configuration; and a filler material 120 that when introduced into the at least one sub-channel through the inlet expands the receptacle into a deployed configuration and thereby forming a barrier with an expanded form.

The flexible material will preferably define at least one sub-channel or channel and may alternatively define a plurality of sub-channels, which could be through channels, reservoirs, chambers, and/or other suitable defined cavities at least partially defined through internal and/or external walls of the receptacle. The receptacle preferably has a high length aspect ratio where the length is multiple orders of magnitude greater than dimensions of a side profile. The receptacle may be characterized as an at least partially extruded form. Manufacturing of the receptacle may or may not use extrusion. Additionally, the structure of the receptacle may not be a continuous extrusion. For example, various sub-channels may end/or terminate and not extend fully through the full length of the receptacle.

As one through-channel implementation variation, the at least one sub-channel can be a through channel extending through the length of the receptacle; the receptacle further comprising an outlet on the opposite length of the receptacle coupled to the at least one sub-channel. A sub-channel may alternatively be a reservoir or chamber sub-channel that has a single opening or is coupled to only inlets.

As a variation of the through-channel implementation variation, the system or receptacle may include a connector that couples the outlet of the receptacle to an inlet of a second receptacle. A series of receptacles can be connected through a connector. A branching connector can couple an outlet of one receptacle to the inlet of multiple receptacles.

The receptacle preferably includes a set of walls that is at least partially made of the flexible material, wherein the set of walls define the at least one sub-channel. The set of walls may include one external wall or a set of external walls. The set of walls may additionally include one or more internal walls that can extend across a side profile of the receptacle to connect two or more walls (external or internal). As a variation of the through-channel implementation variation, the set of walls further includes a set of internal walls, wherein the set of internal walls and external walls define a plurality of sub-channels extending at least portion of the way along the length of the receptacle. The set of walls may additionally provide geometric constraints promoting desired geometry profiles. As shown in FIGS. 10A and 10B, the receptacle may include a set of structural internal walls 1001 (shown as dashed lines) that serve in cooperation with channel walls 1002 as shown as dashed lines. While not represented in all figures structural walls may be strategically positioned to promoted desired geometries and forms. The structural internal walls may terminate periodically, be porous. For example, periodic strips of material may extend across sections to reinforce and provide limits to how a defined cavity can expand.

As a variation of a multiple sub-channel implementation, each sub-channel may be directly coupled to an inlet or indirectly coupled to an inlet through a connected sub-channel. Filler material 120 may enter a sub-channel directly through the inlet for one subset of sub-channels. For another sub-set of sub-channels, filler material 120 may enter a sub-channel through a conduit between the sub-channel and one or more other sub-channels.

As a variation of a multiple sub-channel implementation shown in FIG. 11, the plurality of sub-channels can include a set of reservoir sub-channels 1101 and at least one supply sub-channel 1102. Each of the reservoir sub-channels can include at least one conduit 1103 to the supply sub-channel through which filler material 120 can flow from the supply sub-channel to the reservoir sub-channel; wherein the at least one supply sub-channel is coupled to the inlet and the outlet.

As a variation of the supply sub-channel variation, the supply sub-channel is internally positioned within the expanded form. In one variation, internally positioned can be fully defined by internal walls. Alternatively, internally positioned may be a position removed from the outer exposed external walls, which would generally not include a bottom surface that would not be directly exposed to fire. Accordingly, an internal position may be a position of a sub-channel when defined by internal walls and/or an external wall of a bottom surface can such that it is not directly adjacent to a wall with expected immediate exposure to fire. The bottom surface may be an external wall that is preferably designated as bottom surface for proper installation.

As a variation of the supply sub-channel variation, the at least one conduit to the supply sub-channel can be a one-way valve conduit permitting flow of filler material 120 from the at least one supply sub-channel into a reservoir sub-channel as shown in FIG. 11. There may be multiple one-way valve conduits. In alternative implementations the conduit or conduits may be an opening or connecting channel.

As a variation of a multiple sub-channel implementation, the plurality of sub-channels can include a first sub-channel that when in a deployed configuration is filled with a first filler material 120 and a second sub-channel that when in a deployed configuration is filled with a second filler material 120 that differs from the first filler material 120. As one example variation, the first filler material 120 is a water-based fluid and the second filler material 120 is a fire retardant fluid. There may be third, fourth, and/or other nth sub-channels that may have their own filler material 120 that differ or are the same as the other sub-channels. The different sub-channel filler materials 120 may include variations such as water-based fluids (e.g., water or treated water), fire retardants, and gases. In one variation, a fluid is preferably used as a filler material 120 because of thermal capacity, boiling point, or other features. As shown in the example of FIG. 12, fire retardant filled sub-channels 1201 can be oriented as an outer layer with one external wall defining the cavities, water filled sub-channels 1202 can be oriented adjacent to the fire retardant filled sub-channels, and an air or gas filled sub-channel 1203 can be centrally located to add volume. Fire retardants may be used on sub-channels adjacent to an external wall or close to the outer wall so that the fire retardant can be applied as an initial response when an encroaching fire breaks down an outer wall. Water-based fluids may serve as thermal conduits to facilitate dissipation of thermal energy along the length of the receptacle. Water-based fluids in a similar manner may also serve as a fire extinguishing material if a sub-channel wall is breached. The water-based fluids may additionally provide weight to hold the receptacle in place. A gas-filed sub-channel may serve to expand the volume and may be internally or centrally located within the profile of the receptacle. Other filler material 120 s such as expanding foam and the like could serve similar or alternative purposes.

As a variation of the system implementation and more specifically a multiple sub-channel implementation, when in a deployed configuration, a sub-channel of the plurality of sub-channels can be filled with a water-based fluid, a non-water-based fluid, a fire retardant, a gas, organic solution, particulate solution, a reactive material, and/or any suitable material.

As a variation of the system implementation and more specifically a multiple sub-channel implementation, the plurality of sub-channels can include at least one sub-channel that comprises embedded materials. Embedded materials can be additives that dilute in the filler material 120 such as diluting in water-based filler material 120 to make the water filler material 120 more fire retardant. Embedded materials can alternatively be reactive additives that react to various conditions. The conditions could be environment conditions such as temperature and/or pressure. The conditions could be exposure to a catalyst material. In one variation, the catalyst material is included in the filler material 120. In another variation, the catalyst could be the air or substances outside the receptacle that are encountered if a containing wall is breached. In one example, the embedded material could be a foaming agent that foams when in contact with a filler material 120, which may function to more efficiently fill a volume of the sub-channel.

As a variation of a multiple sub-channel implementation, the receptacle can include at least one sub-channel that when in a deployed configuration extends horizontally. This horizontal extension sub-chamber may be filled with a solid or liquid filler material 120, but may alternatively be filled with a gas (e.g., air). The horizontal extension can extend horizontally from one edge of a base structure. In one variation, there can be two horizontal extensions: a first horizontal extension extending horizontally in one direction from a base structure and a second horizontal extension extending horizontally in a second opposite direction from the other side of the base structure. The horizontal extensions may additionally comprise of multiple sub-channels. A repeated series of horizontal extension sub-channels can be reservoir sub-channels extending outward as shown in FIG. 8 and FIGS. 9A-9C.

As a variation of a multiple sub-channel implementation, the receptacle can include at least one sub-channel that when in a deployed configuration extends vertically from a base surface. This vertical extension sub-chamber may be filled with a solid or liquid filler material 120, but may alternatively be filled with a gas (e.g., air). The vertical extension sub-channels can extend from an upper portion of a base structure. The vertical extension sub-channels can alternatively extend from any suitable point. There may be multiple vertical extension sub-channels so as to establish multiple vertically raised obstacles. Vertical extensions may additionally be configured and coupled to horizontal extensions.

As one implementation variation, the receptacle when in a collapsed configuration is folded along an axis defined along the length of the receptacle collapsing the side profile of the receptacle and subsequently folded across the axis. In another variation, the receptacle when in a collapsed configuration is folded across an axis defined along the length of the receptacle, which can include rolling or folding in a regular pattern.

As one implementation variation, the receptacle can include at least one one-directional valve segmenting the at least one sub-channel. The one-directional valve can be a passive valve formed by a wall opening in an internal wall separating two adjacent sub-channels and a valve mechanism covering the wall opening. The valve mechanism can be one or more flaps that are mounted on the wall side in which filler material can fill and that extend substantially across the opening. Flow in the unintended direction serves to close the flap and seal, close, or at least limit the amount of flow.

As one implementation variation, the receptacle can include an embedded material that expands and seals a conduit between two adjacent sub-channels. This self-sealing conduit can close off access to a reservoir so that after preferably being filled with a filler material 120, a rupture in exposed wall of that sub-channel does not impact connected sub-channels.

As one implementation variation, the receptacle can include spaced instances of partial obstructions extending internally from walls defining the at least one sub-channel. The partial obstructions can be partial walls that spread across a portion of the transverse profile of a sub-channel. The partial obstructions may be staggered so as to create a serpentine path. Various patterns may be used.

As one implementation variation, the receptacle can include an outer surface of the receptacle with a reflective coating.

The system can alternatively be applied to other use-cases such as flood relief and in particular a system for containment and redirection of ingress water, wherein the system can include a receptacle that is at least partially made of a flexible material that defines a sub-channel extending along a length of the receptacle, and the receptacle comprising an inlet to the at least one sub-channel; wherein the receptacle can be arranged in a collapsed configuration; and a filler material 120 that when introduced into the at least one sub-channel through the inlet expands the receptacle into a deployed configuration and thereby forming a barrier with an expanded form. The inlet can preferably be sealed after entering a deployment configuration. While the receptacle can make use of through channels when applied to a water containment barrier, the receptacle may more preferably include one or more reservoir or chambers sub-channels (i.e., more concisely referred to as sub-chambers).

As one implementation variation, a receptacle for a water containment barrier (though alternatively used in other use cases) may include horizontally extending flaps. The horizontal extension flaps can extend horizontally from one edge of a base structure. In one variation, there can be two horizontal extension flaps on opposite sides: a first horizontal extension flap extending horizontally in one direction from a base structure and a second horizontal extension flap extending horizontally in a second opposite direction from the other side of the base structure.

The flaps can be sheets of material and may not necessarily include sub-chambers as with the horizontal extension sub-channels described above. Though expanding sub-channels may also or alternatively be used. The flaps can preferably be used to have supplemental external materials weigh down and hold a deployed barrier in place. In some variations, the horizontal extension flaps may include pockets. The flaps preferably fold up as with the other receptacle material when in a collapsed configuration. When in a deployed configuration, the flaps can be pulled out and used to extend the horizontal coverage. Sandbags, sand, or ballast like materials can be placed on the flaps to anchor the barrier in place.

As another implementation variation, the receptacle can include a series of pockets along an external surface. The pockets can preferably be used to slot sandbags, loose materials, or other suitable ballast materials. In one variation, the series of pockets can extend across the width of a bottom surface of the receptacle and also be repeated down the length of the bottom surface of the receptacle. Pockets could alternatively or additionally be provided along the outer surface to facilitate stacking sandbags or adding other ballast materials on the exposed surface of a deployed barrier.

As another implementation variation, the receptacle includes a set of sub-chambers. The sub-chambers can preferably be configured with a side profile establishing a staggered incline along one, two or more exposed surfaces. The staggered incline may be used to enable other water barrier materials to be easily stacked on top of the deployed barrier. In this way the deployed barrier may be able to quickly provide a central volume as well as a water impenetrable layer, and then additional volume can be gained by adding sandbags or other materials on top of the deployed barrier. Multiple sub-chambers can make the sub-chamber redundant so that an accident rupture does not trigger a total collapse.

The water containment barrier as well as other applications of the system can integrate any of the variations or features described herein.

### 3. Method

As shown in FIG. 5, a method for deploying a portable barrier includes: providing a deployable receptacle in a collapsed configuration S120, placing the deployable receptacle along a desired region S110, and filling the barrier with filler material 120 S130, thereby expanding the deployable receptacle and thereby forming the barrier. The method functions to setup and deploy a barrier system such as the one above. The method may additionally include monitoring state of a deployed and/or undeployed barrier. The method may additionally include regulating supply of filler material 120 during deployment. The expanded barrier when used for fire containment preferably reduces the likelihood of a fire traveling from one side of the barrier to the other side of the barrier, The method may additionally or alternatively be used in deployment of the system as a water/flood barrier, a designation/border type barrier, a landslide barrier, or any other type of desired barrier. In some preferred variations, the method enables deployment as a flame prevention barrier. In these variations, the method may further include filling the barrier with a flame-retardant agent and releasing the flame retardant agent in response to high temperatures and/or a fire.

The method is preferably performed in connection with a system as described above but may alternatively be implemented with any suitable system.

Block S120, which includes providing a deployable receptacle, functions in acquiring an expandable barrier that may be deployable as desired. Providing a deployable receptacle S120 preferably initially provides a device in collapsed configuration with a packed form. The collapsed configuration can ease transportation and/or handling of the device when positioning and setting up the device for deployment. Some variations may alternatively provide the barrier in an unpacked form, or even in an expanded form.

In some variations, providing a deployable receptacle S120 includes providing the deployable receptacle in a vehicle packed form, such that the barrier is packed efficiently (e.g. for a truck or helicopter). In these variations, providing a deployable receptacle S120 may include providing a deployable receptacle that is quickly deployable from the vehicle. This may include connecting the barrier to a deployment system on the vehicle.

Block S110, which includes placing the deployable receptacle along a desired region, functions to place and position the expandable barrier along a region where it will be utilized. Placing the deployable receptacle S110 may include unpacking the barrier at least partially such that it can be easily expanded. Alternatively, the placing the barrier S110 may occur concurrent to filling the barrier S130. In dense areas, placing the barrier S110 may additionally include clearing out space for the barrier; particularly removing sharp objects that may damage the barrier. In some instance, placing a deployable receptacle can include anchoring the receptacle using various anchor points or elements.

In some variations, the placing the barrier S110 may include airdropping the barrier (e.g. from a helicopter). Preferably airdropping the barrier occurs concurrent to filling the barrier 130.

In addition to placing, filler material 120 supply channels can be coupled to one or more inlets. This can happen at the time of setup, at the time when deployment is needed or at any suitable time.

Placing the barrier S110 preferably includes arranging the barrier. Arranging the barrier functions to layering/connecting barrier components for desired functionality. As desired, arranging the barrier, may include: creating a specific barrier shape/geometry, increasing the height or width of the barrier by layering additional, or lengthening the barrier.

Block S130, which includes filling the barrier with filler material, functions to bring the barrier to an expanded deployed or at least partially deployed state. Filling the barrier with a filler material 120 S130 may be either a single step process, completely filling the barrier, or a multi-step process. The multi-step process may be concurrent to placing the barrier S130; that is the barrier may be partially filled, the placement of the barrier adjusted, and then the barrier filled completely. The multi-step filling and placing may take as many desired steps necessary until the barrier is placed in the desired positioning and filled completely. For example, in one air-drop deployment implementation of the barrier, filling the barrier S130 preferably includes a multi-step process, wherein concurrent to “dropping” the barrier”, the barrier is filled sufficiently such that the barrier is expanded to full, or near full, area of the barrier. Once the barrier has landed, the filling the barrier S130 may then include expanding the barrier to full volume.

Filling the barrier may additionally include initially supplying filler material 120 to a first sub-channel and then at a subsequent time supplying filler material 120 to a second sub-channel. Supplying filler material 120 to a second sub-channel may be dependent on some condition such as detected failure in connection with the first sub-channel.

In some preferred variations, the filler material 120 utilized to fill the barrier is water. Other filler material 120 s may be additionally or alternatively used. Examples of other filler material 120 s may include other types of non-corrosive gases or liquids (particularly foams), or organic material. Filling the barrier with a filler material 120 S130 may include filling the barrier with multiple filler material 120 s. Two different filler material 120 s can be supplied to the same sub-channels of a receptacle or to different sub-channels.

In some variations, the barrier functions to reduce flammability of some region proximal to the barrier. In these variations, the method may additionally include filling the barrier with a flame-retardant agent. The filler material 120 and the flame-retardant agent may be the same compound (e.g. water). Alternatively, the flame-retardant agent may be a different compound. In variations where the filler material 120 and the flame-retardant agent are the same compound, filling the barrier with a filler material 120 S130 may also comprise of filling the barrier with a flame-retardant agent. That is, the filler material 120 that expands the barrier may also function as the flame-retardant agent. Alternatively, filling the barrier with a flame-retardant agent may be distinct from filling the barrier with a filler material 120 S130; i.e. the barrier may have a distinct filling region (or regions) for the flame-retardant agent.

In the variations where the barrier functions to reduce flammability of some proximal area, the method may additionally include releasing the flame-retardant agent in response to high temperatures and/or fire. In one variation, wherein the filler material 120 and the flame-retardant agent are the same compound, after the barrier is exposed to fire (and/or heat) for a sufficient period of time, releasing the flame-retardant agent includes the barrier exploding and releasing the filler material 120 contents in the nearby surrounding.

In another variation, releasing the flame-retardant agent comprises of only a section of the barrier exploding and releasing the flame-retardant agent, while the general integrity of the barrier is maintained.

In a third variation, releasing the flame-retardant agent includes spraying out the flame retardant from the barrier. For example, for a semi-porous barrier, high temperatures may increase the pressure of the flame-retardant agent sufficiently to cause the flame-retardant agent to spray out of the pores.

In a fourth variation, part of the barrier may comprise of a material that is less resistant to heat. High temperatures and/or fire may cause the parts of the barrier to open up slowly (e.g. melt) slowly releasing the flame-retardant agent in proximity of the barrier.

The method may additionally include monitoring state of a deployed and/or undeployed barrier, which functions to sensing status. This may be used in detecting failure to the barrier or failure or ruptures to a portion. It may additionally be used in monitoring the advancement of a fire.

The method may additionally include regulating supply of filler material during deployment, which can function to alter the deployment of the barrier. Regulating supply may alter the flow rate (increasing the flow rate, lowering the flow rate, stopping flow rate, starting flow rate, reversing flow rate, etc.), altering the filler material (changing the filler material type or composition), and/or redirecting between different sub-channels. Redirecting between different sub-channels may include detecting failure of one deployed sub-channel, stopping supply of filler material to the failed sub-channel and starting supply of filler material to a non-deployed sub-channel.

As a person skilled in the art will recognize from the previous detailed description and from the figures and claims, modifications and changes can be made to the embodiments of the invention without departing from the scope of this invention as defined in the following claims.

We claim:

1. A system for a fire mitigation barrier deployed along a surface comprising:
a receptacle that includes a set of walls that are at least partially made of a flexible material and that define at least one sub-channel extending along a length of the receptacle, and the receptacle comprising an inlet to the at least one sub-channel;
wherein the receptacle can be arranged in a collapsed configuration; and
a filler material that when introduced into the at least one sub-channel through the inlet expands the receptacle into a deployed configuration and thereby forming a barrier with an expanded form.

2. The system of claim 1, wherein at least one sub-channel is a through channel extending through the length of the receptacle; the receptacle further comprising an outlet on the opposite length of the receptacle coupled to the at least one sub-channel.

3. The system of claim 2, further comprising a connector that couples the outlet of the receptacle to an inlet of a second receptacle.

4. The system of claim 3, the set of walls further comprising a set of internal walls, wherein the set of internal walls and external walls define a plurality of sub-channels extending at least portion of the way along the length of the receptacle.

5. The system of claim 4, wherein each sub-channel is directly coupled to an inlet or indirectly coupled to an inlet through a connected sub-channel.

6. The system of claim 4, wherein the plurality of sub-channels comprises of a set of reservoir sub-channels and at least one supply sub-channel, wherein each of the reservoir sub-channels comprise at least one conduit to the supply sub-channel through which filler material can flow from the supply sub-channel to the reservoir sub-channel; wherein the at least one supply sub-channel is coupled to the inlet and the outlet.

7. The system of claim 6, wherein the supply sub-channel is internally positioned within the expanded form.

8. The system of claim 6, wherein the at least one conduit to the supply sub-channel is a one-way valve conduit permitting flow of filler material from the at least one supply sub-channel into a reservoir sub-channel.

9. The system of claim 4, wherein the plurality of sub-channels comprise of a first sub-channel that when in a deployed configuration is filled with a first filler material and a second sub-channel that when in a deployed configuration is filled with a second filler material that differs from the first filler material.

10. The system of claim 9, wherein the first filler material is a water-based fluid and the second filler material is a fire retardant fluid.

11. The system of claim 4, wherein, when in a deployed configuration, a sub-channel of the plurality of sub-channels is filled with a gas.

12. The system of claim 4, wherein the plurality of sub-channels comprises of at least one sub-channel that comprises embedded materials.

13. The system of claim 4, wherein the receptacle includes at least one sub-channel that when in a deployed configuration extends horizontally.

14. The system of claim 4, wherein the receptacle includes at least one sub-channel that when in a deployed configuration extends vertically from a base surface.

15. The system of claim 2, wherein when in a collapsed configuration, the receptacle is folded along an axis defined along the length of the receptacle collapsing the side profile of the receptacle and subsequently folded across the axis.

16. The system of claim 2, wherein the receptacle comprises of at least one one-directional valve segmenting the at least one sub-channel.

17. The system of claim 2, wherein the receptacle comprises of spaced instances of partial obstructions extending internally from walls defining the at least one sub-channel.

18. The system of claim 2, wherein the filler material is a water-based fluid.

19. The system of claim 2, wherein the filler material comprises of a fire retardant substance.

20.The system of claim 2, wherein an outer surface of the receptacle has a reflective coating.
